(19) United States
(12) Patent Application Publication
(10) Pub. No.: US 2025/0235874 A1
(43) Pub. Date: Jul. 24, 2025

(54) BIOMASS FEEDSTOCK RECOVERY EQUIPMENT AND PROCESSES

(71) Applicant: ENERGY CREATES ENERGY LLC, Kansas City, MO (US)

(72) Inventors: Caden PERRY, Greenwood, MO (US); Matthew PERCIFIELD, Kansas City, KS (US); John Casey YUNGER, Shawnee, KS (US); Kyle Tucker WATTS, Lee's Summit, MO (US)

(21) Appl. No.: 19/171,742

(22) Filed: Apr. 7, 2025

Related U.S. Application Data
(63) Continuation of application No. 18/561,403, filed on Nov. 16, 2023, now abandoned.
(60) Provisional application No. 63/193,329, filed on May 26, 2021.

(51) Int. Cl. B02C 13/282; D01B 1/28; D01B 1/46

(52) U.S. Cl. CPC B02C 13/282; D01B 1/28; D01B 1/46

(57) ABSTRACT

The present disclosure is broadly concerned with processing equipment and methods for processing of a biomass feedstock into one or more biomass particles of reduced size, and in particular, hemp. The vertical impact liberating equipment and methods can process whole hemp stalks into hemp particulates comprising distinct fractions of hemp hurds, bast fiber, and fines. Advantageously, in preferred embodiments, the biomass feedstock is pulled through a defined gap and into a defined chamber. This action causes a successive decrease and increase of pressure within the biomass feedstock, yielding the one or more biomass particles of reduced size.

### CROSS-REFERENCE TO RELATED APPLICATIONS

The present application is a continuation of U.S. patent application Ser. No. 18/561,403, filed Nov. 16, 2023, which is the U.S. National Stage of International Patent Application No. PCT/US2022/031018, filed May 26, 2022, which claims the priority benefit of U.S. Provisional Patent Application Ser. No. 63/193,329, filed May 26, 2021, entitled BIOMASS RECOVERY EQUIPMENT AND PROCESSES, each of which is incorporated by reference in its entirety herein.

### BACKGROUND OF THE INVENTION

### Field of the Invention

The invention relates to novel processing equipment and methods for processing a fibrous biomass feedstock, such as hemp.

### Description of Related Art

The 2018 Farm Bill legalized hemp and hemp-derived products under federal law in the United States, while hemp has been legalized in Canada since 1998. Hemp is naturally tough with woody stalks, making it applicable for a variety of commercial and industrial applications, including everything from clothing and beauty products to building materials and biofuel. In addition, its oil can be extracted for cannabidiol (CBD) products. However, its toughness also means that it is nearly impossible to break down with traditional equipment used for most common fibrous biomass like corn.

Industrial hemp, also known as non-psychoactive hemp, refers to cannabis sativa plant cultivars that are grown specifically for industrial use, and it should not be confused with psychoactive cannabis. Industrial hemp focuses on the use of the hemp plant material, which is composed of the stalk, seeds, and leaves of the plant and marketed as a seed, fiber, or dual-purpose crop. From the roots to the leaves, each component of the hemp plant can be processed and made into an industrial hemp product. For example, the hemp stalk can be used to make rope, paper, insulation, building materials, and animal bedding. The stalk's bast fibers are used to make hemp textiles, and they can be blended with other fibers. CBD extracts also come from the plant's stalks and stems through the process of CBD extraction. However, many hemp manufacturers are only interested in hemp flowers, buds, and seeds, regarding the remaining stalks and leaves as waste. However, these products, like other kinds of agricultural biomass, can be processed into useable articles including for fibers, composites, textiles, cords, rope, and further can be converted into ethanol or biofuel.

Again, however, hemp processing typically requires different or additional equipment to process the hemp biomass as compared to other agricultural biomass. In a conventional process, the hemp stalks and leaves are subjected to a multi-step process involving sequential pieces of equipment. First, the woody core or “hurd” is separated from the bast fiber. There are typically two approaches to separating bast fiber and hurd: mechanical decortication or retting. Mechanical decortication can be carried out by hand or by using a decorticating machine. Retting is a biochemical process, in which enzymes produced by microorganisms attack the pectins that glue together fiber cells, aiding the separation of fiber bundles within the bast fiber. Retting is typically carried out in water or by dew retting which involves laying out stalks in an open field and allowing rain or humidity (dew) along with naturally occurring or added microorganisms or fungi to break down the stalks. After softening, the stalks still need to be sent through a decorticator or stripped by hand. In general, the farmer may carry out the retting process on their land, and then transport the hemp to a different facility for decortication.

After decortication, the fiber is scutched and hackled. Scutching refers to the dressing of the hemp in preparation for spinning. Scutching is typically carried out in a scutch mill that beats the fiber bundles to further separate longer fibers from the hurd. It is followed by “hackling,” which combs shorter or broken fibers out of the stalk and aligns them in a continuous sliver for spinning.

A modern decorticator separates the fiber from the rest of the stem and uses post-processing to remove the fiber's resins and gums. A hammermill, for example, can be used to separate the plant's hurds from the bast fiber. The bast fiber is then cleaned, carded, refined, and cut to size. Once ready, the fibers can then be pressed tightly and prepared for baling. Processed bast fibers arrive at hemp product manufacturing facilities packaged in compressed bales similar to hay.

Although the vast majority of hemp is processed only once it has been dried and retted in the field, wet processing technology is also being explored. Nevertheless, there still remains a need for improvements in hemp processing, particularly for processes that do not require so many separate steps, transport of the hemp among various locations, and multiple pieces of equipment.

### SUMMARY OF THE INVENTION

The present disclosure is broadly concerned with processing equipment and methods for processing of a biomass feedstock into one or more biomass particles of reduced size, such as, hurds, bast fiber, and fines. In general, the current disclosure concerns equipment and methods for single-step processing of hemp biomass into its respective useable components: fiber, hurd, and hemp fines.

More particularly, in some embodiments, a process for one-pass size reduction of fibrous biomass is described. The process comprises passing a biomass feedstock through an inlet of a vertical impact liberator comprising: a housing having a plurality of sidewalls, a rotatable shaft, a plurality of cutter discs arranged in a spaced-apart stack along said shaft, and a fan assembly mounted inside the housing below the stack of cutter discs, said fan assembly comprising a fan disc having a direction of rotation and one or more fan blades connected to the fan disc for pulling air through said housing; each cutter disc having an outer edge and at least one hammer mounted on the cutter disc and extending radially outwardly past the outer edge of the cutter disc, said housing having a plurality of shelves extending inwardly from respective sidewall sections and presenting an inner edge, the at least one hammer rotating in closely spaced relation to an upper surface of the respective shelf, wherein a gap is defined between the inner edge of the shelves and the outer edge of a respective cutter disc and hammer, wherein a chamber is formed between each opposing pair of cutter discs in the spaced-apart stack. Then, the process comprises collecting one or more biomass particles of reduced size at an outlet of the vertical impact liberator.

In yet another embodiment, a vertical impact liberator for processing biomass feedstock is described. The vertical impact liberator comprises: an inlet; a housing connected to said inlet, said housing having a plurality of sidewalls, a rotatable shaft comprising a plurality of anti-wrap blocks, at least one anti-wrap shield, a plurality of cutter discs arranged in a spaced-apart stack along said shaft, and a fan assembly mounted inside the housing below the stack of cutter discs, said fan assembly comprising a fan disc having a direction of rotation and one or more fan blades connected to the fan disc for pulling air through said housing; each cutter disc having an outer edge and at least one hammer mounted on the cutter disc and extending radially outwardly past the outer edge of the cutter disc, said housing having a plurality of shelves extending inwardly from respective sidewall sections and presenting an inner edge, the at least one hammer rotating in closely spaced relation to an upper surface of the respective shelf, wherein a gap is defined between the inner edge of the shelves and the outer edge of a respective cutter disc and hammer, wherein a chamber is formed between each opposing pair of cutter discs in the spaced-apart stack; and an outlet connected to said housing.

### BRIEF DESCRIPTION OF THE DRAWINGS

FIG. (FIG. 1A is a perspective view of the vertical impact liberating equipment according to one aspect of the disclosure;

FIG. 1B is a top plan view of the liberating equipment according to one aspect of the disclosure;

FIG. 1C is a bottom plan view of the liberating equipment according to one aspect of the disclosure;

FIG. 1D is a cross-sectional view of the liberating equipment according to one aspect of the disclosure taken generally along line 2-2 in FIG. 1A;

FIG. 1E is a top-down view of a cutter disc with hammers along line 3-3 in FIG. 1D;

FIG. 1F is a top-down view of the fan assembly;

FIG. 2A is a cross-sectional view showing path of travel of the processed biomass;

FIG. 2B is a cross-sectional view of the upper half of the liberating equipment according to one aspect of the disclosure taken generally along line 2-2 in FIG. 1A;

FIG. 2C is a close-up of the gap A;

FIG. 2D is a cut-away view of the first and second chambers and anti-wrap cylinders;

FIG. 3 is the first half of a flowchart illustrating methods for processing biomass feedstock and for further processing the resulting biomass particles of reduced size;

FIG. 4 is the second half of the flowchart shown in FIG. 3;

FIG. 5 shows two photographs (a) and (b) each containing a side-by-side comparison of conventional bast ribbons and the biomass particles of reduced size processed according to one aspect of the disclosure;

FIG. 6 is a photograph of hemp fiber collected directly out of the vertical impact liberating equipment, screened, and spun into a blended yarn (˜60% Wool and 40% Hemp fiber);

FIG. 7 is a photograph of an exemplary biomass feedstock (whole hemp stalks and straw) that can be fed directly into the vertical impact liberating equipment;

FIG. 8 is a photograph of biomass particles of reduced size consisting of hurds, bast fiber, and fines collected immediately after exiting the outlet of the liberating equipment according to one aspect of the disclosure;

FIG. 9A is a photograph of large, separated hemp hurds processed according to one aspect of the disclosure;

FIG. 9B is a photograph of large, separated hemp hurds (16 mesh retained) processed according to one aspect of the disclosure;

FIG. 10A is a photograph of medium, separated hemp hurds (20 mesh retained) processed according to one aspect of the disclosure;

FIG. 10B is a photograph of small, separated hemp hurds (30 mesh passing) processed according to one aspect of the disclosure;

FIG. 11 is a graph showing the hurd chip particle distribution from hemp hurds processed according to one aspect of the disclosure;

FIG. 12A is a photograph of separated bast hemp fibers and residual hemp hurds processed according to one aspect of the disclosure;

FIG. 12B is a photograph of carded bast hemp fibers processed according to one aspect of the disclosure;

FIG. 13 is a photograph of #2 microgreens/fines processed according to one aspect of the disclosure and collected from a mill (not screened);

FIG. 14 is a graph showing the microgreen/fines particle distribution from hemp fines processed according to one aspect of the disclosure;

FIG. 15A is a photograph of hemp fines (˜1,000 μm or less) processed according to one aspect of the disclosure;

FIG. 15B is a photograph of ultra-fine hemp fines (˜150 μm or less) processed according to one aspect of the disclosure;

FIG. 16 is a graph showing the particle size analysis distribution of the hurd chip particle distribution data shown in FIG. 11 and the microgreen/fines particle distribution data shown in FIG. 14.

### DETAILED DESCRIPTION

The present disclosure is concerned with vertical impact liberating equipment and methods for processing biomass feedstock. In at least one embodiment, the vertical impact liberating equipment and methods liberate (decorticate) dried and separated fibrous and nonfibrous biomass (e.g., hurds, bast fibers, and fines) from biomass feedstock. As used herein, the term “hurds” is synonymous with “shives” and refers to the woody fibers (e.g., having a woodchip like consistency) that originate from the inner woody core of the biomass feedstock stalk that is liberated from the bast fiber. As used herein, the term “bast fibers” refers to the long plant fibers found in the phloem (the skin or inner bark) of the biomass feedstock stalk that is liberated from the hurd. As used herein, the term “fines” refers to the hulls, seeds, microgreens, and pulverized powder liberated from the feedstock during processing. Advantageously, the disclosed system can liberate the different biomass components in a single step, and more particularly in a single pass through a single piece of equipment to yield dried and separated hurd, fiber, and hemp fines having a reduced size and favorable characteristics.

The resulting fibrous and nonfibrous biomass have a reduced particle size as compared to the biomass feedstock introduced into the liberating equipment. Thus, methods of the disclosure concern a single pass process for reducing whole hemp stalks into particulate hemp comprising distinct fractions of hurd, fiber, and fines. The hurd, fiber, and fines are differentiated from one other by particle size, but also by physical composition. Moreover, the disclosure concerns a system where the size-reduced hemp can be immediately processed, screened, liberating equipment, and notably can then be immediately processed into byproducts (e.g., biodiesel, biochar, textile, fiber, yarn, wool, or crude seed oil), screened, or segregated into distinct fractions within a single in-line system.

### Vertical Impact Liberating Equipment

The vertical impact liberating equipment may be any equipment capable of processing fibrous biomass feedstock materials, such as hemp, into smaller particulates. For example, the vertical impact liberating equipment may be a vertical axis grinder, of the type described in detail in U.S. Pat. No. 7,950,601, issued May 31, 2011, or U.S. Pat. No. 9,403,167, issued Aug. 2, 2016, or U.S. Pat. No. 10,799,873, issued Oct. 13, 2020, each of which is incorporated by reference herein in its entirety.

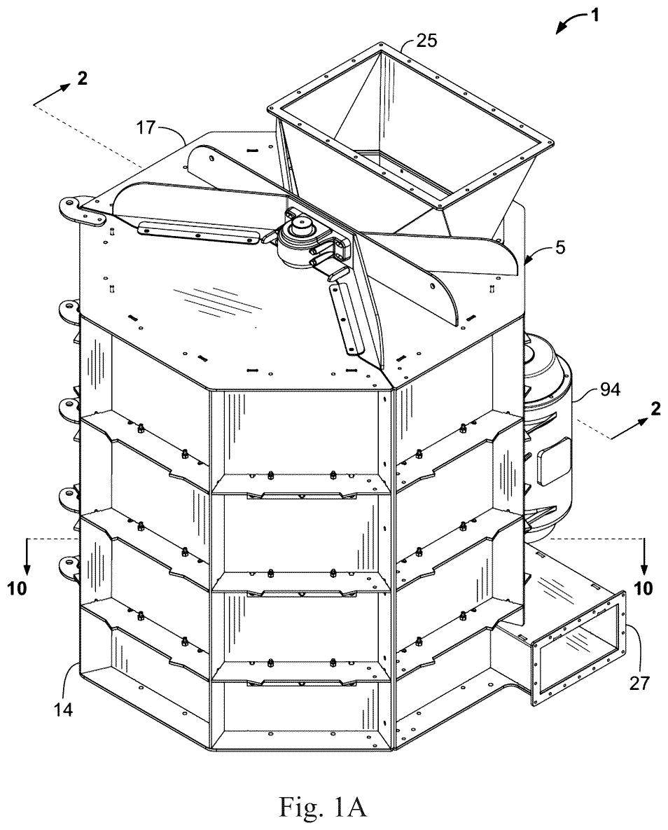

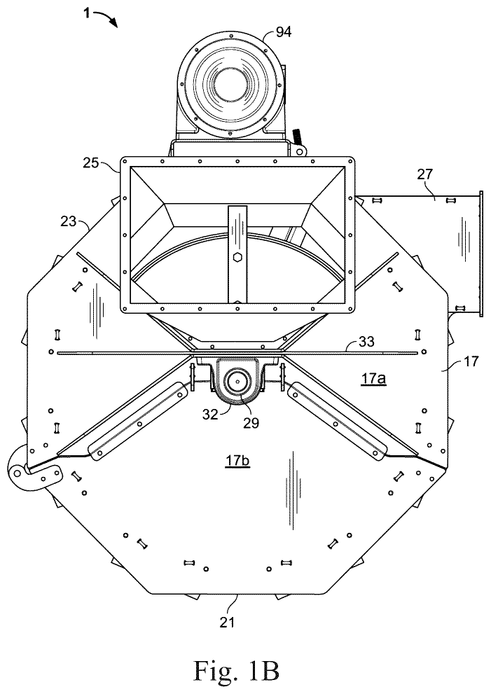

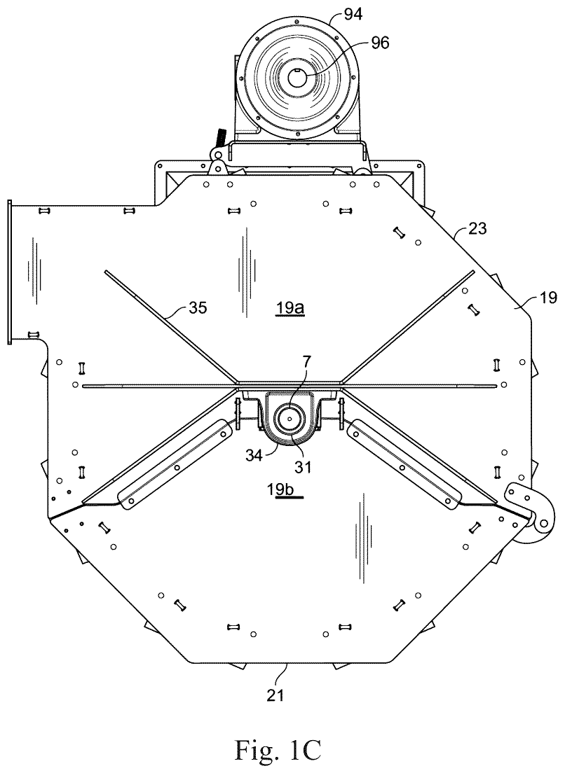

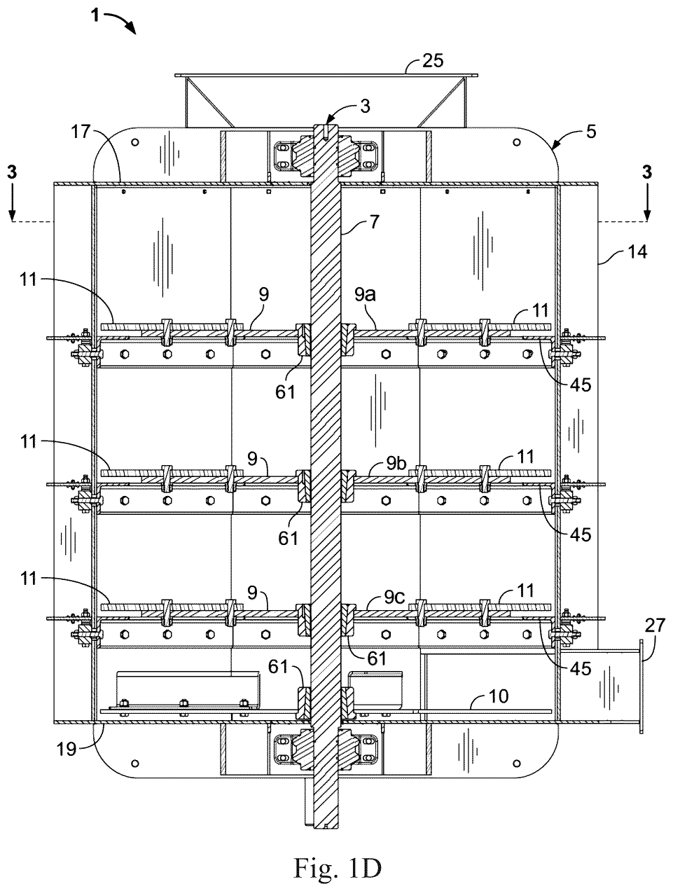

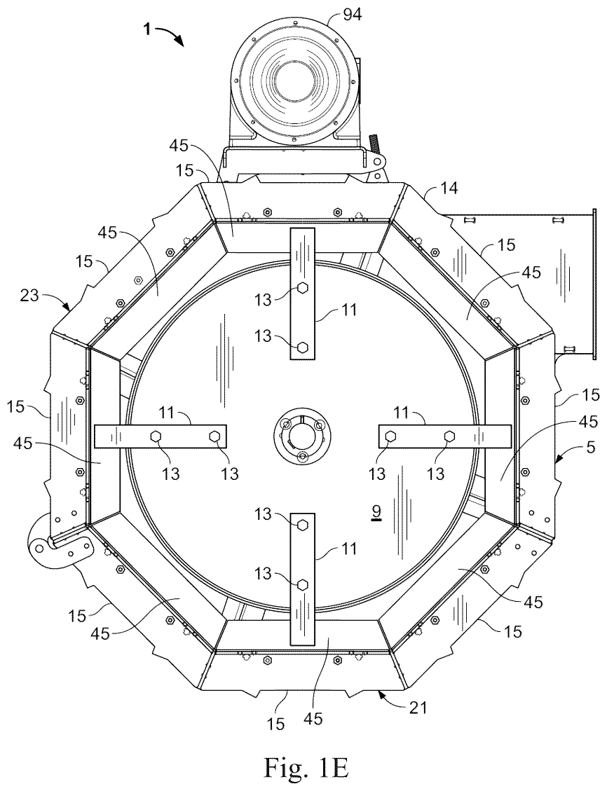

Preferred vertical impact liberating equipment may be more readily understood with reference to the figures. Turning to FIG. 1, the vertical impact liberator 1 generally comprises a rotor 3 rotatably mounted in a housing 5. The rotor 3 includes a generally vertical shaft 7 and a plurality of cutter discs 9 longitudinally mounted on the shaft 7 and extending radially outward therefrom. In one or more embodiments, the cutter discs 9 have a substantially circular shape/annular circumference. A fan disc 10 is connected to the shaft 7 below the lowermost of the cutter discs 9 and spaced downwardly therefrom. In one or more embodiments, the fan disc 10 is a substantially circular shape/annular circumference. The drawings show three cutter discs 9 denominated as discs 9a, 9b, and 9c from top to bottom, with the fan disc 10 spaced downwardly from cutter disc 9c. Each cutter disc 9 comprises a top surface, an opposing bottom surface, and an outer edge. Each cutter disc 9 comprises a plurality of cutter blades or hammers 11 connected thereto that extend radially outward past the outer edge of the respective cutter disc 9. Four hammers 11 arranged at 90-degree intervals are shown for each of the cutter discs 9. The hammers 11 are each shown as being rigidly connected and/or mounted to the top surface of the respective cutter disc 9 by a pair of bolts 13. It is foreseen, however, that each hammer 11 could be fastened by only a single bolt 13 so as to pivot or swing about the bolt 13 relative to the respective cutter disc 9. It is also foreseen that each hammer 11 could be fastened by a single bolt 13 or plurality of bolts 13 to an intermediate bracket (not shown), and the bracket could therefore be fastened by a single bolt 13 or plurality of bolts 13 to the respective cutter disc 9.

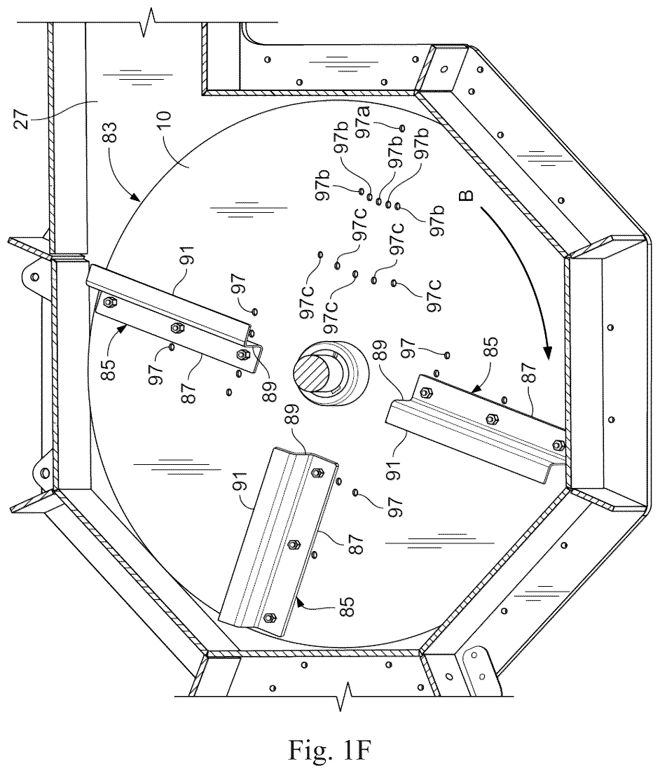

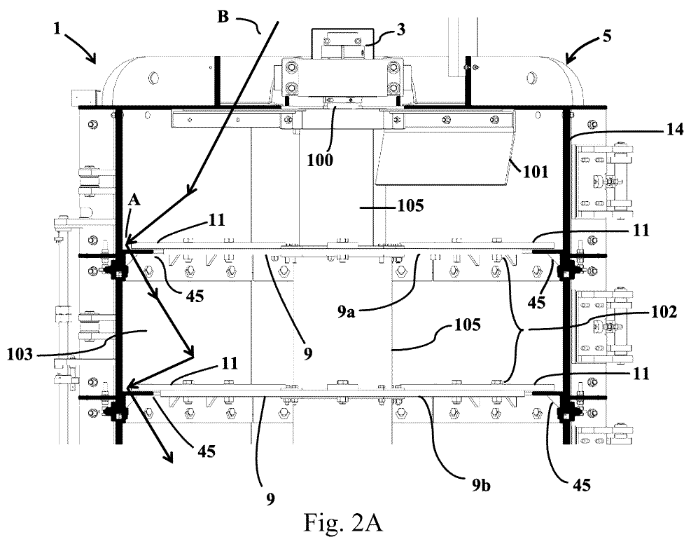

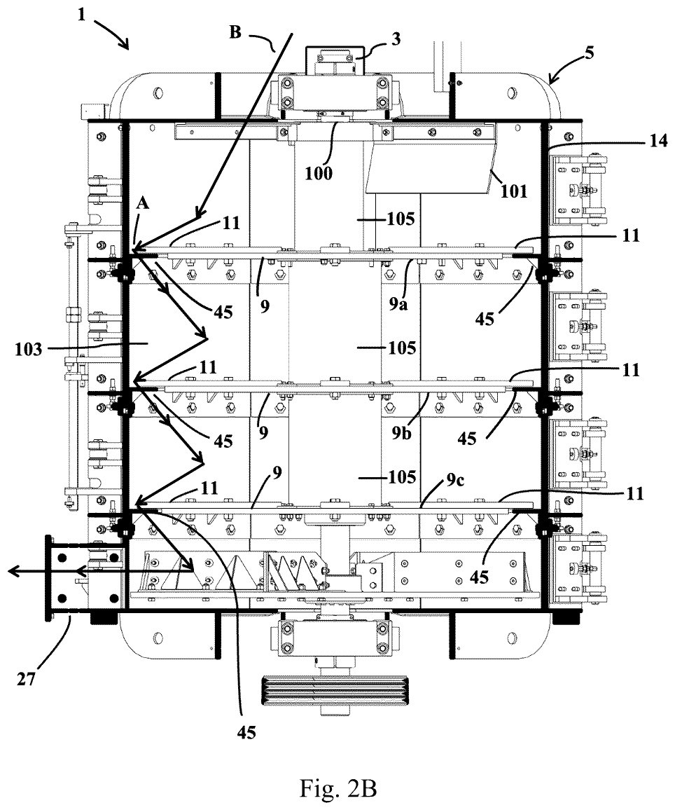

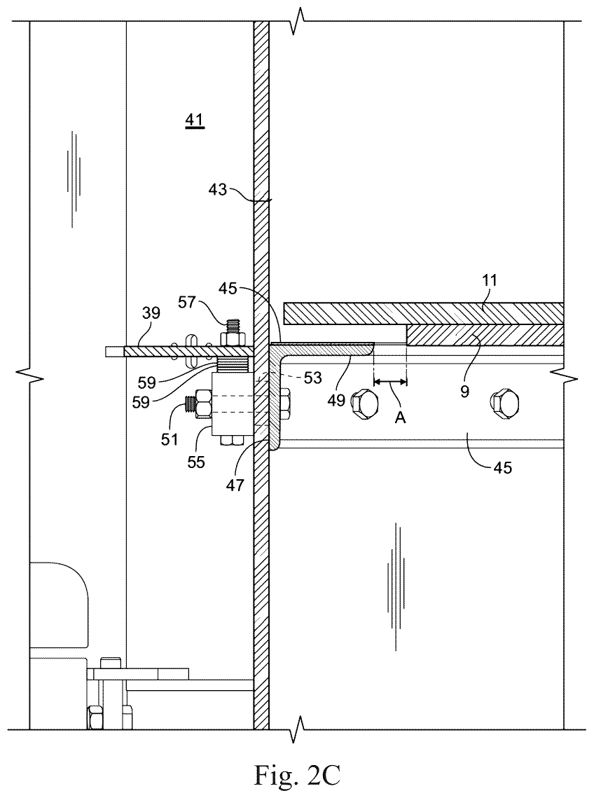

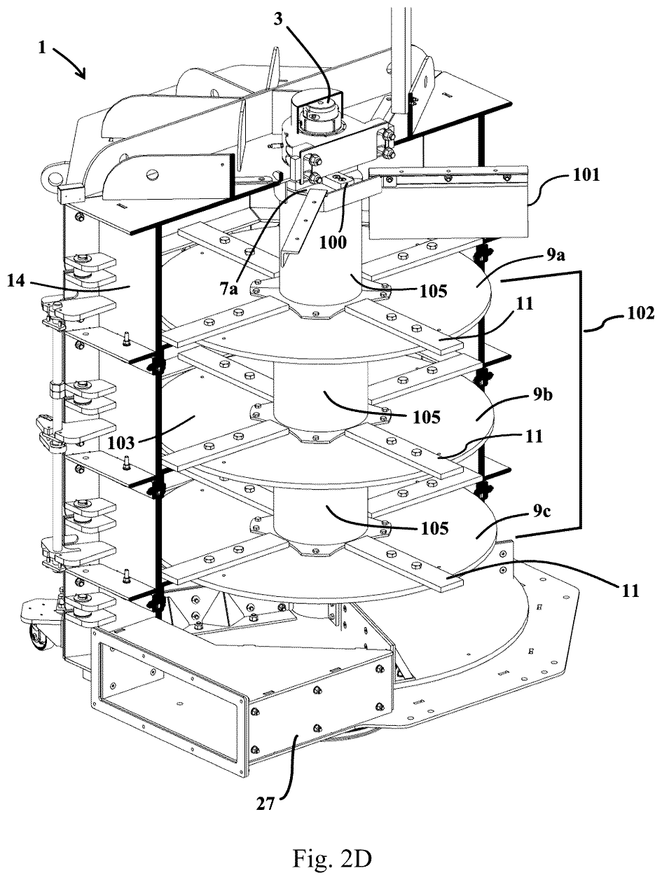

In another embodiment, as shown in FIG. 2 the vertical impact liberator 1 may also include a cylinder or cylindrical housing 105 encasing at least a portion of the length of the center shaft 7. The cylindrical housing 105 can be positioned around the shaft 7 above the top cutter disc 9a, and for example, can rest on top of the top cutter disc 9a. The cylindrical housing may likewise be positioned on each of the subsequent cutter discs 9b and 9c. The cylindrical housing 105 can vary in circumferential dimension relative to the length of feedstock being processed. The circumference of the cylindrical housing 105 is preferably greater than the length of the longest non-rigid material feedstock (e.g., longer than the longest fibers of the biomass to be processed). The cylindrical housing 105 functions to prevent or resist wrapping of the fibrous feedstock around the rotatable shaft 7.

Referring back to FIG. 1A-1F, the housing 5 is generally octagonal in shape and includes a sidewall 14 comprising eight sidewall sections 15, a top wall 17 and a bottom wall 19, which enclose a grinding chamber (in which the shaft 7, cutter discs 9, and fan disc 10 are housed). The housing 5 includes a door 21, comprising three of the sidewall sections 15, which is hingedly connected to a main housing 23 which comprises the remaining five sidewall sections 15. The top and bottom walls 17 and 19 are each divided into respective first sections 17a and 19a that form part of the main housing 23 and respective second sections 17b and 19b that form part of the door 21. The line of division between the first sections 17a and 19a and the second sections 17b and 19b preferably extends through the axis of rotation of the shaft 7 such that the rotor 3 may be easily installed or removed through the opening provided by swinging open the door 21. An entrance chute/inlet 25 for admitting biomass into the vertical impact liberator 1 is formed on the top wall 17 and communicates with the interior/grinding chamber of the housing 5 through an opening in the top wall 17. In one or more embodiments, the top wall 17 is removable from the housing 5 and can be rotated as needed to position the inlet 25 in the desired location for ease of access. A discharge chute/outlet 27 for discharging processed biomass from the vertical impact liberator 1 is formed through the sidewall 14 and communicates with the interior of the housing 5 through an opening formed in the sidewall 14. The discharge chute/outlet 27 opening is positioned such that the bottom edge of the opening is below the plane of the underside of the fan disc 10 (and preferably, the bottom edge of the opening can be substantially planarly aligned with the plane of the bottom wall 19 of the housing 5). Likewise, the discharge chute/outlet 27 opening is positioned such that the top edge of the discharge chute/outlet 27 opening is above the top of the fan blades 85, but below the bottom edge of the lowermost cutter disc 9. Thus, the height of the discharge chute/outlet 27 opening as measured from its bottom edge to its top edge, extends from a plane below the fan disc 10 (and preferably planarly aligned with the bottom wall 19) to a plane aligned with the bottom edge of the lowermost cutter disc 9 in the vertical impact liberator 1, but in any event at least extends to a plane aligned with the top of the fan blades 85.

Each sidewall section 15 includes a sidewall framework 37 comprising a plurality of horizontal ribs 39 extending between vertical ribs 41, as depicted in FIG. 1D. A respective replaceable wear plate 43 covers the interior of each sidewall framework. Mounted to the interior surface of each wear plate 43 are a plurality of angle deflectors 45, the number of angle deflectors 45 on each sidewall section 15 being equal in number to the number of cutter discs 9. As shown more closely in FIG. 2C, each angle deflector 45 includes a vertical flange 47 positioned in abutment against the interior surface of the respective wear plate 43 and a horizontal flange 49 that extends inwardly from the respective sidewall section 15. The angle deflectors 45 are positioned such that the horizontal flanges 49 are each in general alignment with a portion of the outer edge of a respective one of the cutter discs 9 such that the respective hammers 11 move in closely spaced relation to the upper surface of the horizontal flange 49. More preferably, the angle deflector top surface is planarly aligned with the bottom surface of the cutter disc 9. As shown in FIG. 1E, the ends of the angle deflectors 45 are cut at an angle (such as approximately 67.5 degrees) such that the horizontal flanges 49 of angle deflectors 45 on adjacent sidewall sections 15 cooperate to form octagonal shelves (45) that extend continuously around the interior of the housing 5. Alternatively, the ends of the angle deflectors 45 can be cut such that the horizontal flanges 49 of the angle deflectors 45 on adjacent sidewall sections 15 cooperate to form arcuate or rounded (concave) shelves that extend continuously around the interior of the housing. However, in one or more embodiments, one or more angle deflectors 45 may be removed from its respective sidewall section 15 to define a void between the outer edge of its respective cutter disc 9 and the particular sidewall section 15.

The angle deflectors 45 are mounted to the respective sidewall sections 15 in such a manner that the position of each angle deflector 45 can be fine-tuned to insure proper alignment relative to the respective cutter disc 9. As noted, one or more angle deflectors 45 can also be removed entirely from its respective sidewall section 15. Referring again to FIG. 2C, a plurality of bolts 51 extend through holes in the vertical flange 47 of each of the angle deflectors 45, through oblong or oversize openings 53 in the respective wear plate 43, and through horizontal holes in a respective adjustment block 55. The adjustment blocks 55 are each connected to the sidewall framework 37 by vertical bolts 57 that extend through aligned holes in the adjustment block 55 and in a respective one of the horizontal ribs 39 of the respective sidewall framework 37. Shims, washers or spacers 59 can be placed around the vertical bolts 57 between the adjustment block 55 and horizontal rib 39 to adjust the height of the adjustment block 55 and connected angle deflector 45 within the range of the oblong openings 53 in the respective wear plate 43.

A gap A is defined between the outer edge of each cutter disc 9 and the inner edge of the horizontal flanges 49 of the respective angle deflectors 45. In one or more embodiments, the cutter discs 9a, 9b, and 9c are of somewhat increasing diameter from the top to the bottom of the vertical impact liberator 1 such that the size of the gap A decreases from top to bottom (and the material has to pass through progressively decreases gap sizes before reaching the bottom chamber 103 and outlet 27). The cutter discs 9a, 9b, and 9c may also be of decreasing diameter from the top to the bottom of the mill 1 such that the gap A increases from top to bottom.

Referring to FIG. 1F, the fan disc 10 forms part of a fan assembly 83 which acts to provide airflow through the vertical impact liberator 1 and to thereby improve drying of the biomass, to help move biomass through the vertical impact liberator 1, and to expel the ground biomass through the discharge chute/outlet 27. The fan assembly 83 includes a plurality of fan blades 85 which are affixed to the upper surface of the fan disc 10 in a generally radial orientation (mounted on top of the fan disc 10). Four fan blades 85 are provided in the embodiment depicted with three of the fan blades 85 being shown in FIG. 1F. The fourth fan blade 84 has been deleted to show detail that would otherwise be concealed by the deleted fan blade 85. The fan blades 85 each include a bottom flange 87 securable to the fan disc 10, and an upwardly extending web 89 (that extends away from the upper surface of the fan disc 10 and towards the cutter discs 9 above). In some embodiments as shown, the fan blades 85 also include a top flange 91 that extends outwardly from the web 89 in the direction of rotation of the fan disc 10 (designated by arrow B). More specifically, in one embodiment of the fan blade 85, the web 89 extends generally vertically upward from the leading edge of the bottom flange 87 (in the direction of rotation B of the fan disc 10). The top flange 91 then extends generally horizontally outward from the top edge of the web 89, again in the direction of rotation of the fan disc 10. It is foreseen, however, that the angles between the bottom flange 87, web 89, and top flange 91 could be other than right angles, and/or that the top flange 91 may be omitted. It will also be appreciated that the bottom flange 87, web 89, and optional top flange 91 may be unitarily formed as a unitary (monolithic) piece. Alternatively, the bottom flange 87, web 89, and optional top flange 91 may be separate, individual pieces that have been welded or otherwise joined together. The fan blades 85 may also be of uniform thickness, but may also have reinforced sections of greater thickness, particularly in the web 89. The bottom flange 87 of each of the fan blade 85 has a plurality of mounting holes formed therein for receiving fasteners 95 (three shown) used to connect the fan blades 85 to the fan disc 10. The fan disc 10 has mounting holes 97 formed therein for receiving the fasteners 95. It is preferred, however, that there be extra mounting holes 97 in the disc 10 to allow the blades 85 to be selectively repositioned to adjust the airflow through the vertical impact liberator 1. For example, the disc 10 is shown in the drawings as having a single mounting hole 97a proximate the outer edge of the disc 10 for the outermost of the fasteners 95. The remaining fasteners 95 are provided with multiple mounting holes 97, arranged in arcuate rows. Five mounting holes 97b are shown for the middle fastener 95, and five mounting holes 97c are shown for the innermost fastener 95. By selectively pivoting the fan blades 85 about the fastener 95 in the outermost hole 97a and selecting different pairs of the mounting holes 97b and 97c, an operator of the vertical impact liberator 1 can adjust the angular orientation of the fan blades 85 relative to a true radial orientation and thereby increase or decrease the airflow through the vertical impact liberator 1 to best suit specific biomass to be ground and operating conditions.

It will also be appreciated that the fan blades 85 can be positioned in a number of different arrangements on the fan disc 10, other than a strictly radial arrangement, which refers to blades extending straight out from the center of the hub 61. In addition, the fan blades 85 themselves may be of varied shapes. Examples which are known for centrifugal fan configurations, in addition to radial flat blades, include forward-curved blades, backward-curved blades, forward-inclined blades, and backward-inclined blades. Forward-curved blades curve in the direction of the fan disc rotation. Backward-curved blades curve against the direction of the fan disc rotation. Forward-and backward-inclined blades are straight, not curved, but extend at an angle, other than straight out from the center of the hub 61.

The rotor 3 of the vertical impact liberator 1 is driven by a motor 94 which may be, for example, an electric or hydraulic motor. The motor 94 can be mounted to the vertical impact liberator 1 in any suitable configuration using any suitable attachment elements (e.g., bolts, screws, brackets, and combinations thereof). In one or more embodiments, the motor 94 is mounted to one of the sidewall sections 15 and includes a shaft 96 which is operably connected to a lower portion of the shaft 7 that extends below the bottom wall 19 of the housing 5, such as by a chain and sprocket or belt and sheave system, or hydraulic drive system 98. In operation, the motor's operation drives rotation of the rotor 3, which in turn drives rotation of the shaft 7 and respective cutter discs 9a, 9b, 9c arranged along the shaft 7. The amperage and/or speed of the rotation of the discs 9 can be adjusted as needed via adjustment of the controls operating the motor 94 parameters.

The system may include a conveyor belt (or other conveyance system) for feeding the biomass feedstock into the inlet 25, and in these embodiments, may further include electronic controls for feeding/metering the biomass feedstock into the inlet 25 at a desired rate (e.g., depending upon how fast the liberator 1 is running and how quickly the feedstock is being pulled through the different chambers 103 of the spaced apart stack 102 of cutter discs 9a, 9b, 9c).

Turning to FIG. 2, and operation of the liberator 1, the rotor 3 is preferably contained with one or more anti-wrap blocks 100 and at least one anti-wrap shield 101. As illustrated, the plurality of cutter discs 9a, 9b, 9c are preferably arranged in a spaced-apart stack 102 along the rotatable shaft 7, and a chamber 103 is formed between each opposing pair of cutter discs 9 in the spaced-apart stack 102. As best seen in FIG. 2C, the gap A is adjustable depending upon the particular shape and position of the respective shelves/angle deflectors 45, cutter disc 9, and hammer/blades 11. Moreover, the shape and size of the gap A can be further adjusted by removing one or more respective shelves/angle deflectors 45 and/or one or more hammers/blades 11. For example, in one or more embodiments, one or more sidewall sections 15 may have one or more respective shelves/angle deflectors 45 removed. As an example, any one, two, or three of the top, middle, or bottom shelf/angle deflector 45 may be removed from a respective sidewall section 15, or even from two or more sidewalls sections 15. As an example, the top shelf/angle deflector 45 may be removed for two or more of the respective sidewall sections 15, or from all of the sidewalls sections in a particular configuration (e.g., the configuration would have no shelves/angle deflectors 45 at the top). Likewise, a similar modification may instead be made by removing the middle shelf/angle deflector 45 from one or more (or all) sidewall sections 15. Likewise, a similar modification may instead be made by removing the bottom shelf/angle deflector 45 from one or more (or all) sidewall sections 15. Furthermore, modifications may be made by removing one or more hammers/blades 11 from any of cutter discs 9a, 9b, and/or 9c. Furthermore, the alignment of any of the cutter discs 9a, 9b, and/or 9c with its respective top, middle, and/or bottom shelves/angle deflectors 45 can be adjusted so that the respective cutter disc 9a, 9b, and/or 9c is raised further above its respective shelf/angle deflector 45 to increase the spaced relation with the hammers/blades 11 and thus, the size of the gap A, or is lowered to decrease the spaced relation with the hammers/blades 11 and thus, the size of the gap A. Likewise, the diameter of the cutter discs 9a, 9b, and/or 9c can be adjusted to be smaller or larger (and do not have to be all of the same diameter) so that the distance between the edge of the cutter disc 9a, 9b, and/or 9c and its respective shelf/angle deflector 45 is increased or decreased.

As discussed in further detail below, the rotation of the fan assembly 83 and cutter discs 9 generates a sucking pressure inside the liberator 1 and by pulling (as opposed to pushing) the feedstock through gap A and into chamber 103, the vertical impact liberator 1 is advantageously capable of processing the biomass feedstock into the one or more biomass particles of reduced size in a single pass through the machine.

As mentioned above, the housing 5 preferably comprises at least one anti-wrap shield 101, and the shaft 7 (encased by cylindrical housing 105) preferably comprises a plurality of anti-wrap blocks 100 at the top of the first chamber 103. Fibrous biomass feedstock, such as hemp, is notorious for wrapping around spinning objects during processing, so it will be appreciated that the anti-wrap blocks 100 and anti-wrap shield 101 prevent the biomass feedstock from wrapping around the rotor 3 and shaft 7 upon entering the housing 5. That is, the anti-wrap blocks 100 and shield 101 block access of the biomass feedstock material to the shaft 7 until the feedstock can be pulled down from the inlet 25 into a first chamber 103. In most preferred embodiments, the plurality of anti-wrap blocks 100 are attached to a top surface 7a of the shaft 7, and the at least one anti-wrap shield 101 is arranged between the inlet 25 and the shaft 7.

As illustrated in FIGS. 2B-2C, the biomass feedstock is passed through the vertical impact liberator 1 so that it moves from the inlet 25 to the discharge chute/outlet 27. The feedstock preferably passes through path B and is pulled downward by the rotation of the fan assembly 83 and through the discharge chute/outlet 27. As shown in FIG. 2B, path B is defined by a series of vertically stacked cutter discs or blades 9 with corresponding hammers 11. As the biomass feedstock travels along path B, the biomass feedstock is impacted by the shelves/angle deflectors 45, sidewall sections, cutter discs 9a, 9b, 9c, and hammers 11 as it moves through the housing 5, preferably through the respective gaps A formed (as described above) before each chamber and then is discharged from the outlet 27.

After processing, in one or more embodiments, the resulting dried and liberated particles of reduced size may be diverted into a collection chamber (not shown), which by virtue of volume or ancillary air, may have a neutral or negative air pressure (i.e., to further facilitate “pulling” of the particles from the discharge chute/outlet into the collection chamber). Advantageously, the air pressure and velocity in the collection chamber allows for the removal of the majority fines by virtue of their pick-up velocity. In some embodiments, the collection chamber may be configured to reduce roping or packing the biomass particles or configured to adjust the air pressure/air flow, temperature, and volume (bin full sensor) in the chamber. From the collection chamber, the remaining hurds, bast fiber, and residual fines can be then conveyed to other equipment for additional processing, if desired.

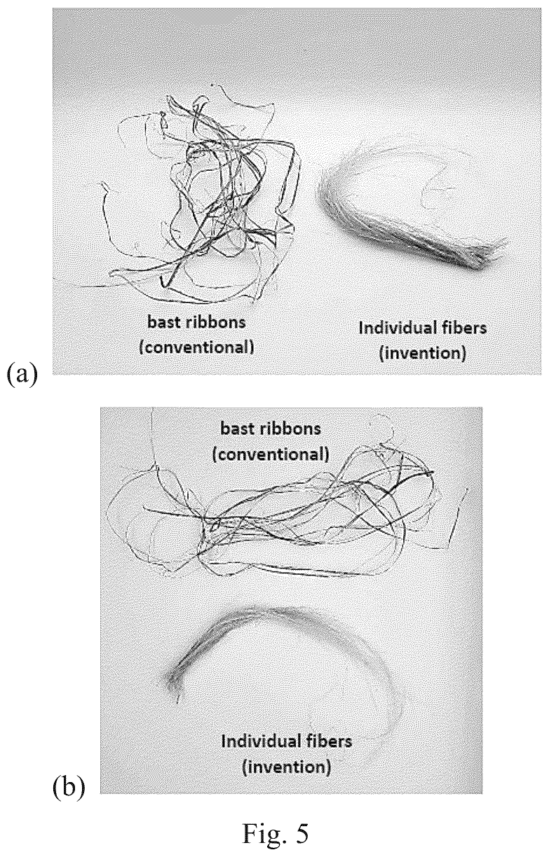

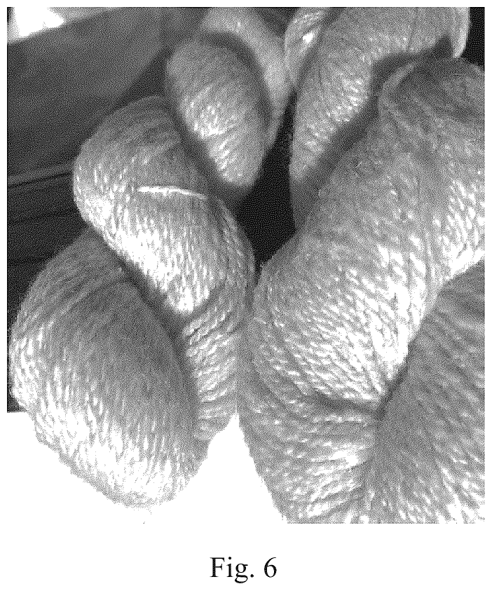

It will be appreciated that the liberating equipment is capable of advanced fiber refinement while processing a biomass feedstock into one or more biomass particles of reduced size in a single step/single pass. That is, the one-step or single-pass liberating equipment avoids the need for various upstream or downstream processing equipment and/or steps, including the use of degumming equipment, drying equipment, hammer mills, decorticators, and the like. For example, traditional processing equipment leaves the fiber of the plant/biomass in strips that look as if the fiber was peeled off the stalk (sometimes referred to as bast ribbons). In other words, the fibers are still attached to each other in a thick strip of the stalk. In contrast, the inventive liberating equipment incorporates fiber stripping into the single pass liberating process, thus separating the individual fibers from each other. FIG. 5 shows a side-by-side comparison of conventional bast ribbons and the biomass particles of reduced size processed according to one aspect of the disclosure. These stripped fibers exit the liberating equipment in a form that can be directly spun into yarn or string as shown in FIG. 6. As a result, the equipment avoids the need for additional fiber refinement processing.

### Methods for Processing Biomass Feedstock

The present disclosure also concerns methods for processing a fibrous biomass feedstock into one or more biomass particles of reduced size, such as hurds, bast fiber, and fines. Particularly, the method comprises passing a biomass feedstock through the inlet of the vertical impact liberating equipment while it is running (i.e., the cutter discs are rotating), preferably the above-described vertical impact liberator, and collecting the one or more biomass particles of reduced size at the discharge chute/outlet of the liberating equipment.

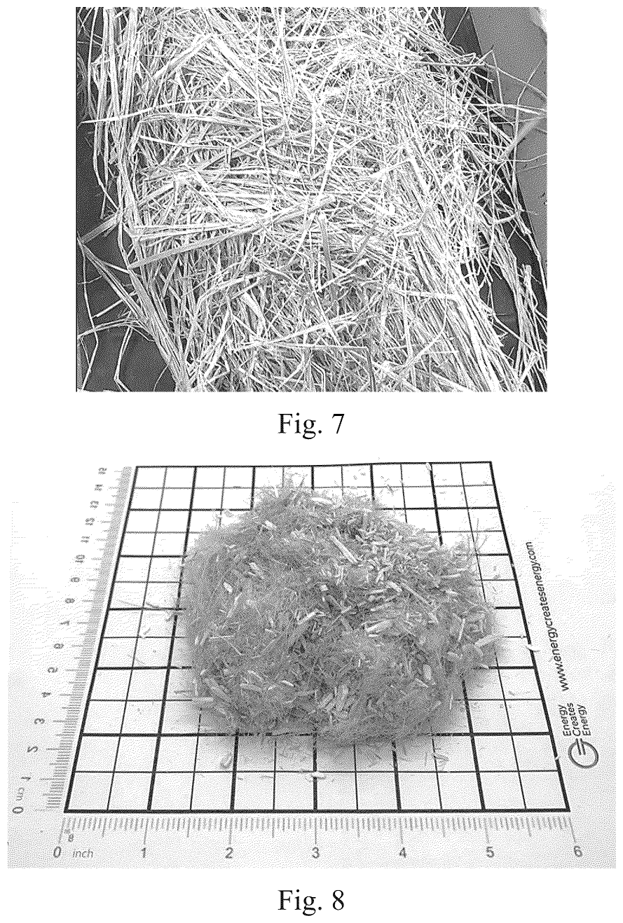

The biomass feedstock can be loose, bagged, boxed, round bale, or square bale, in wet, damp, or dry condition. That is, it is not necessary for the biomass feedstock to be pre-cut, shredded, or pre-dried before it is passed through the liberating equipment. For example, FIG. 7 shows an exemplary biomass feedstock (hemp) that can be fed directly into the vertical impact liberating equipment after it has been started according to embodiments of the disclosure. The biomass feedstock may be, but is not limited to, hemp (including retted or unretted stalk), industrial hemp, CBD hemp, CBD biomass, CBD bushel stalk (with or without buds), or plants similar to hemp, such as flax, corn, cotton, tobacco, cannabis, milkweed, nettle, dogbane, jute, kenaf, ramie, roselle, okra, kudzu, linden, paper mulberry, urena, and the like. The raw feedstock may be presorted into specific sizes or grades or with specific fiber or hurd components; however, an advantage of the disclosure is that it is not necessary for the feedstock to be pre-cut, shredded, dried, or otherwise presorted before being introduced into the liberating equipment. In embodiments where the biomass feedstock is hemp, the hemp may be of any shape, gestation period, or cultivar that is of the genus Cannabaceae. In some preferred embodiments, the biomass feedstock comprises whole hemp stalks and straw. As used herein, the phrase “whole” hemp stalks or straw refers to stalks and straw of hemp plants that can be processed “as is” after the conventional harvesting of the plants for their flowers, seeds, and buds, without being further chopped, cut, or pre-treated.

In operation, the liberating mill is started, and the desired speed of rotation, amperage parameters, etc., are set using the controls. Advantageously, the biomass feedstock can then be introduced automatically into the liberating equipment (e.g., using a trommel or bale unroller) and conveyance equipment (e.g., conveyor belt), and does not need to be manually positioned or precisely aligned parallel to the direction of conveyance into the liberating equipment, as required by current fibrous feedstock handling technology. Rather, the biomass feedstock only needs to be positioned in a manner that does not cause the feedstock to block the inlet or become stuck crosswise perpendicular to the direction of conveyance into the inlet. That is, in the current disclosure, it will be appreciated that the biomass feedstock can be fed into the equipment “end-on,” sideways, or even at an angle, with the only caveat being that longer stalks of feedstock should avoid becoming stuck crosswise so as to block the inlet. However, to further facilitate the passing of the biomass feedstock through the vertical impact liberating equipment, existing handling equipment can be used to handle and unpackage the biomass feedstock so that it can be arranged on a conveyor belt (or other conveyance system) for feeding into the inlet of the liberating equipment. In these embodiments, the biomass feedstock should be positioned on the conveyor belt so that the stalks will not impede the direction of conveyance into the inlet of the liberating equipment. In one or more embodiments, the system includes electronic controls for feeding/metering the material fed into the inlet of the liberating machine to maintain desired amperage pull, speed (Hz), and other data points desired during operation of the liberating machine at a desired metric. Different parameters and data points that can be adjusted or affected by adjustment of the speed of the infeed include amperage pull, vibration, heat/temperature, airflow, movement sensors, and possibly tensions when working with specific feeding equipment for unpackaging the hemp (e.g., bail unroller). These may need to be adjusted depending upon the characteristics of the material itself (its moisture content) as well as ambient conditions (e.g., heat/temperature and humidity).

Once the biomass feedstock passes through the inlet of the vertical impact liberating equipment, the feedstock is processed into one or more biomass particles of reduced size, particularly hurds, bast fiber, and fines. As described in detail above, the biomass feedstock travels along path B, and is pulled through the gap A and into each chamber of the liberator by the action of the rotating fan assembly and cutter discs and the associated centrifugal forces generated inside the machine. By pulling or sucking the feedstock through the gap, a specific pressure drop occurs inside the fibrous material of the feedstock, from neutral pressure to negative internal pressure, causing the fibrous material to implode. Upon exiting the gap A, the pressure change in the chamber creates the opposite effect of positive internal pressure in the fibrous material, subsequently resulting in an implode then explode action within the fibrous material, and particularly within the tough woody stalks. In other words, the internal pressure initially drops within the feedstock, imploding the material through intense suction, then the pressure immediately increases within the feedstock once it passes through the gap into the chamber, where the feedstock explodes. Once the implode-to-explode process happens the liberated bast fiber is thrown and beaten through centrifugal force created by the spinning shaft and hammers mounted on the cutter discs, thus, detaching all of the plant's inner woody core off the bast fiber. The pressure change also liberates valuable fines and various sized hurd chips in the process, which are all collected at the discharge chute/outlet.

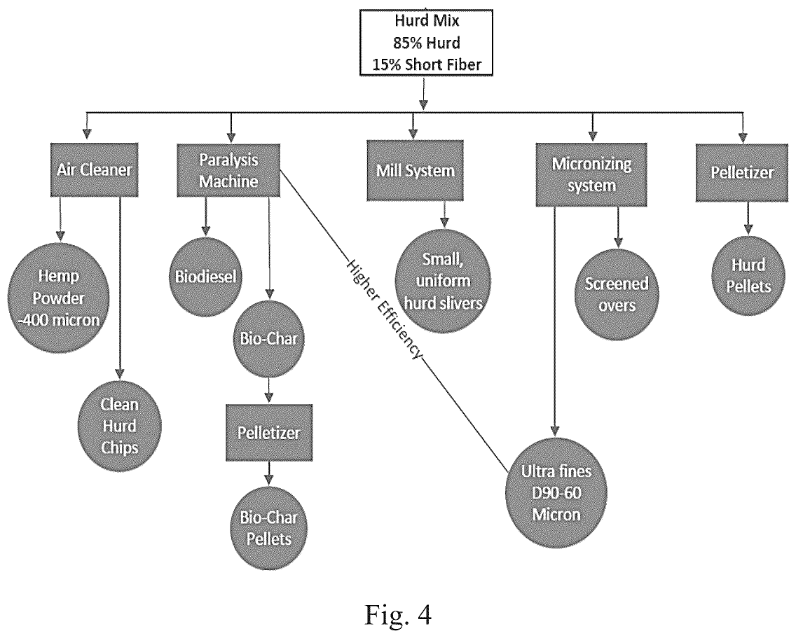

As discussed in more detail below, the resulting biomass particles of reduced size can then be conveyed to one or more additional pieces of equipment for separation (e.g., into hurds, bast fiber, and fines) according to the specifications for an end product. Various fiber refinement and separation technologies exist, including those shown in FIG. 4 and/or those borrowed from corn, cotton, flax, and other fibrous material processing. Non-limiting examples include aspiration, screening, agitation, chemical treatment, carding/cleaning, and the like. The separated biomass can then be packaged for storage, sale, or transport for downstream use, which can be facilitated by compression bagging of fiber, pelletizing, and the like.

It will be appreciated that the above-described processing methods induce several advantageous changes in the biomass feedstock.

First, in addition to automatically sorting and liberating biomass components having different sizes, the process also yields biomass components having different physical characteristics. As discussed above, the process detaches the feedstock's hurds (i.e., inner woody core) from its bast fiber and also liberates valuable fines and various size hurd chips in the process, of which are all collected at the discharge chute/outlet. For example, FIG. 8 shows a photograph of feedstock particulates consisting of hurds, bast fiber, and fines collected immediately after exiting the discharge chute/outlet of liberating equipment according to one aspect of the disclosure.

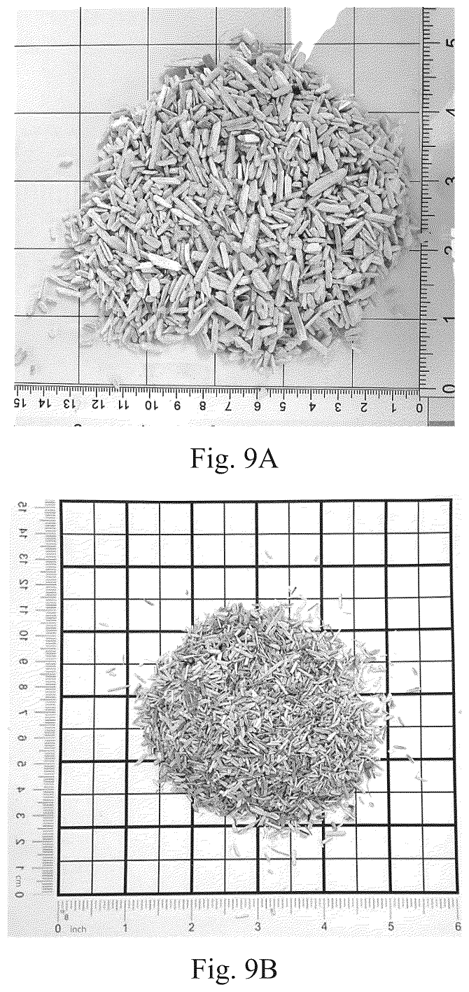

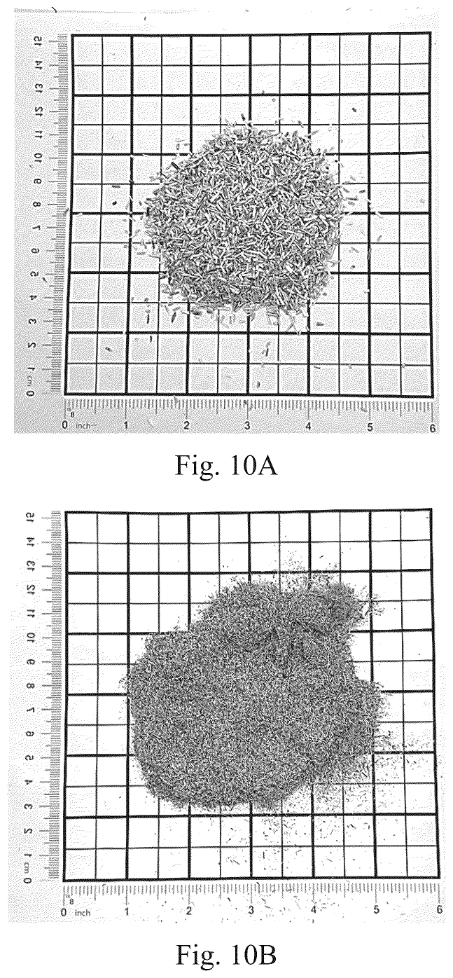

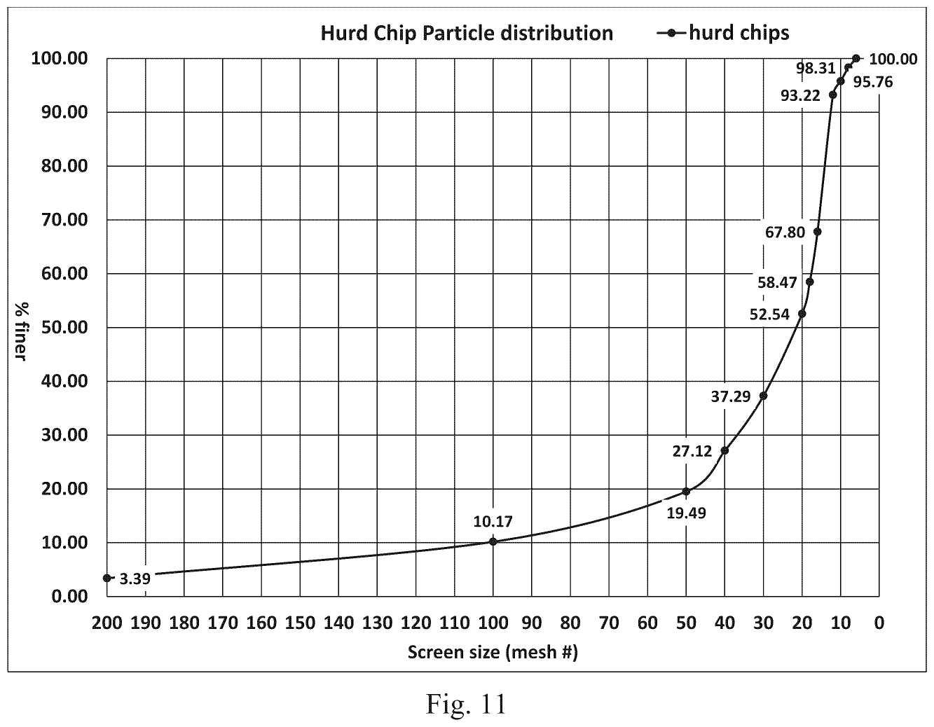

The combination of the impact vertical shredding design and the airflow results in liberation of the hurd from the bast fiber and simultaneous chopping up of distinct hurd sizes that can be further segregated downstream, such as those shown in FIGS. 9 and 10. Particularly, the hurds have a particle size of from about 0.075 mm to about 3 mm, preferably about 0.3 mm to about 2.5 mm, and more preferably about 1 mm to about 2 mm. In most preferred embodiments, the hurds have a particle size distribution as illustrated in Table 1, which corresponds to the data shown in FIG. 11.

TABLE 1
Hurd Particle Size Distribution (according to one aspect of the disclosure)

| | Screen | | Sieve and | Material | % of total | | |
|---|---|---|---|---|---|---|---|
| Mesh | size | Sieve | material | weight | material | ΣW | % |
| # | (mm) | weight | weight (g) | (g) | weight | (%) | finer |
| 6 | 3.35 | 473 | 473 | 0 | 0 | 0 | 100.00 |
| 8 | 2.36 | 455 | 457 | 2 | 1.694915254 | 1.694915254 | 98.31 |
| 10 | 2 | 446 | 449 | 3 | 2.542372881 | 4.237288136 | 95.76 |
| 12 | 1.7 | 423 | 426 | 3 | 2.542372881 | 6.779661017 | 93.22 |
| 16 | 1.18 | 392 | 422 | 30 | 25.42372881 | 32.20338983 | 67.80 |
| 18 | 1 | 370 | 381 | 11 | 9.322033898 | 41.52542373 | 58.47 |
| 20 | 0.85 | 377 | 384 | 7 | 5.93220339 | 47.45762712 | 52.54 |
| 30 | 0.6 | 362 | 380 | 18 | 15.25423729 | 62.71186441 | 37.29 |
| 40 | 0.425 | 340 | 352 | 12 | 10.16949153 | 72.88135593 | 27.12 |
| 50 | 0.3 | 319 | 328 | 9 | 7.627118644 | 80.50847458 | 19.49 |
| 100 | 0.15 | 300 | 311 | 11 | 9.322033898 | 89.83050847 | 10.17 |
| 200 | 0.075 | 300 | 308 | 8 | 6.779661017 | 96.61016949 | 3.39 |

| | | | | | | |
|---|---|---|---|---|---|---|
| Pan | 284 | 288 | 4 | 3.389830508 | 100 | 0.00 |
| | 6314 | 4959 | 118 | 100 | | |

Depending upon the desired features of the product, hurd particle size can be adjusted by modifying the particular shape and position of the cutter disc/blades and respective shelves/angle deflectors of the liberating equipment, by altering the size and disposition of the gap (i.e., defined between the cutter disc, blades/hammers, and the shelves) formed in the liberating equipment, by altering the speed of the rotor and/or shaft, or by adding moisture (e.g., water), CaCO₃, or other chemicals to the material before or after the liberating process.

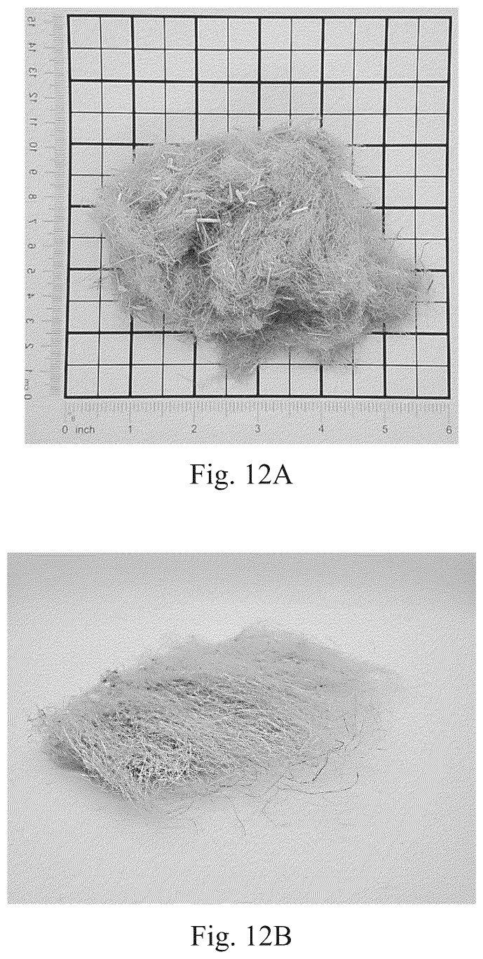

The combination of the impact shredding design and the airflow advantageously results in liberation of the bast fiber from the hurd in the material while maintaining control of the length of the fibers and further maintaining fiber integrity. In embodiments where the biomass feedstock is hemp, different cultivars of hemp have particular fiber characteristics that result in longer or shorter fibers. Advantageously, while maintaining control of the fiber's integrity and length, the above-described process yields fiber from the hurds in the feedstock that can then be separated downstream, such as those shown in FIG. 12A and FIG. 12B. Particularly, the bast fibers have a length of from about 0.5 mm to about 700 mm, preferably about 3 mm to about 610 mm, more preferably about 11 mm to about 500 mm, and most preferably about 25 mm to about 155 mm. Like hurd particle size, bast fiber length can be further adjusted (e.g., a more processed and/or cottonized fiber or a thicker, less processed fiber) by modifying the particular shape and position of the cutter disc/blades and respective shelves/angle deflectors of the liberating equipment, by altering the size and disposition of the gap between the cutter disc, blades/hammers, and the shelves/angle deflectors, by altering the speed of the rotor and/or shaft, or by adding moisture (e.g., water), CaCO₃, or other chemicals to the material before or after the liberating process.

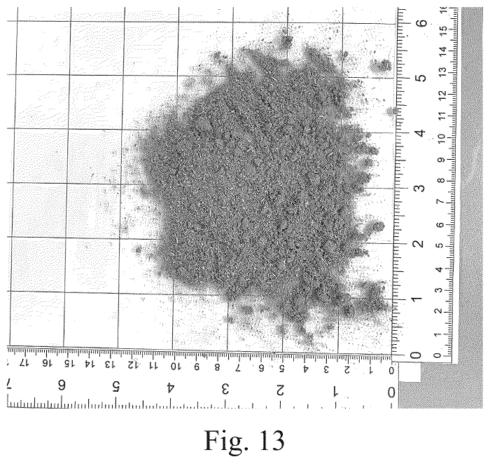

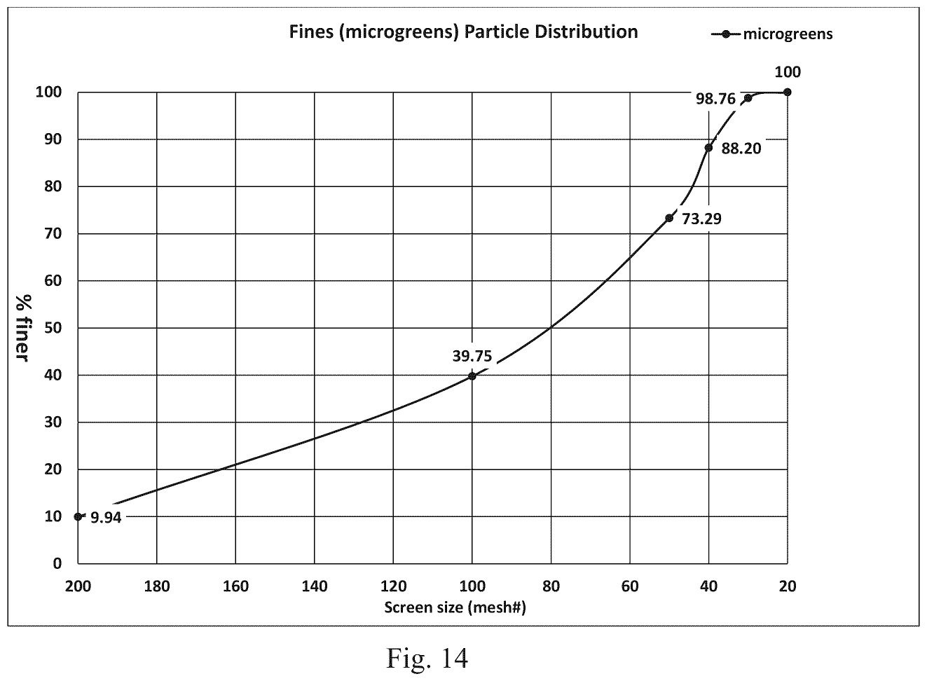

The combination of the impact shredding design and the airflow results in production of a distinct fraction of the output comprising hemp fines that can be collected at the discharge chute/outlet and further screened or segregated downstream. It will be appreciated that the above-described process yields fines that can be collected at the discharge chute/outlet and further screened or segregated downstream, such as those shown in FIG. 13. Particularly, the fines component has a particle size of less than about 1 mm mesh, preferably from about from about 0.075 mm to about 1 mm, preferably about 0.1 mm to about 0.85 mm, and more preferably about 0.1 mm to about 0.6 mm, and more preferably from about 0.1 mm to about 0.5 mm. In most preferred embodiments, the fines have a particle size distribution as illustrated in Table 2, which corresponds to the data shown in FIG. 14. Preferably, ultra-fines are defined as having an average particle size of 150 μm or less, while fines are defined as having an average particle size of 1,000 μm or less.

TABLE 2
Fines Particle Size Distribution (according to one aspect of the disclosure)

| | Screen | Sieve | Sieve and | Material | | | |
|---|---|---|---|---|---|---|---|
| Mesh | size | weight | Material | Weight | % of total | ΣW | % |
| # | (mm) | (g) | weight (g) | (g) | weight | (%) | finer |
| 20 | 0.85 | 377 | 377 | 0 | 0 | 0 | 100.00 |
| 30 | 0.6 | 362 | 364 | 2 | 1.242236025 | 1.242236025 | 98.76 |
| 40 | 0.425 | 340 | 357 | 17 | 10.55900621 | 11.80124224 | 88.20 |
| 50 | 0.3 | 319 | 343 | 24 | 14.9068323 | 26.70807453 | 73.29 |
| 100 | 0.15 | 300 | 354 | 54 | 33.54037267 | 60.2484472 | 39.75 |
| 200 | 0.075 | 300 | 348 | 48 | 29.8136646 | 90.0621118 | 9.94 |

| | | | | | | |
|---|---|---|---|---|---|---|
| Pan | 284 | 300 | 16 | 9.937888199 | 100 | 0.00 |
| | 5944 | 2443 | 161 | 100 | | |

Like hurd particle size and bast fiber length, fine particle size (e.g., more or less fines or ultra fines) can be adjusted by using any one of the techniques described above.

Second, the moisture of the biomass feedstock is reduced. The airflow generated by the liberating equipment induces a drying of the biomass as it moves through the machine. The cubic feet per minute (CFM) of the airflow through the liberating equipment can be adjusted by altering the speed of the rotation of the discs, by adjustments to ancillary air input/output at the front or back of the housing, as well as by using air dampers to introduce or restrict airflow in the equipment. Further, the initial moisture content of the biomass feedstock can also affect air flow.

Third, the above-described process can be carried out at a single location, thereby reducing the need for transporting the particles of reduced size. In embodiments where the one or more biomass particles of reduced size is bast fiber, the fibers advantageously do not need to be stripped. As previously discussed, traditional processing equipment leaves the fiber of biomass in strips that look as if the fiber was peeled off the stalk. In contrast, the above-described process incorporates fiber stripping, thus separating the individual fibers from each other, as shown in FIG. 5. However, if desired, the one or more biomass particles of reduced size can advantageously be further screened, sized, and separated as needed using various separation processes, such as those shown in FIG. 4.

### Uses for Biomass Particles of Reduced Size

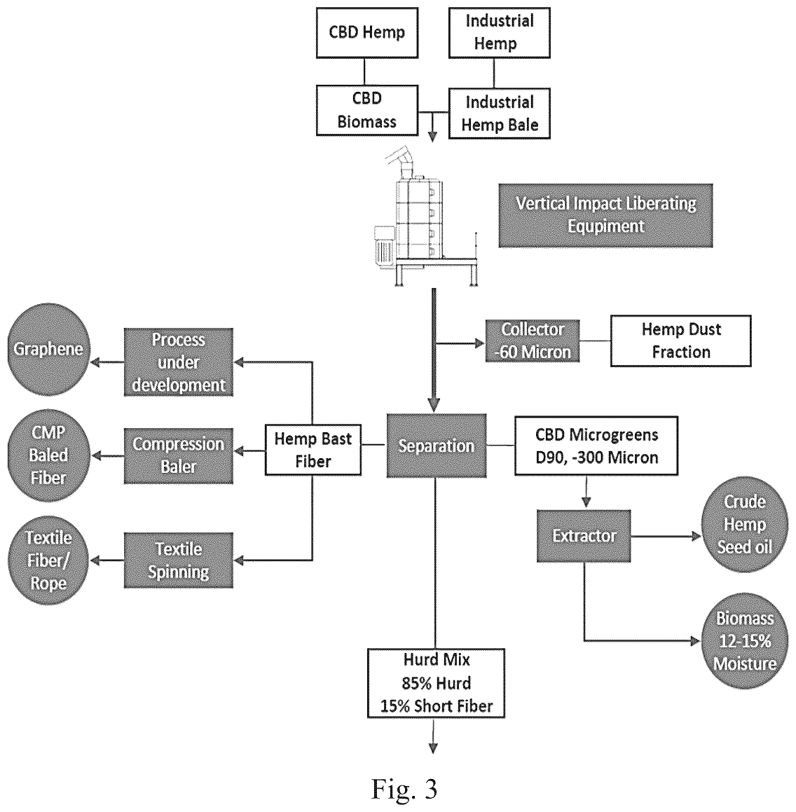

It will also be appreciated that, because the biomass particles of reduced size do not need to be further chopped, shredded, ground, or dried, the particles may be immediately subjected to downstream processing at the same location or a different location for incorporation into a wide variety of byproducts and/or uses by using suitable equipment to yield the desired byproduct or use, as shown in FIGS. 3-4. Particularly, the biomass particles of reduced size can be processed into byproducts, such as, but not limited to, animal bedding, bags, biodiesel, biochar, biochar pellets, biocomposites, biofuel/ethanol, canvas, carpet, cardboard, chemical absorbent, clothes, CMP baled fiber, concrete, cordage/rope, crude seed oil, fiberboard, filters, graphene, biomass (12%-15% moisture), hemp powder, hurd pellets, hurd chips (including clean hurd chips), insulation, mulch, netting, non-wovens, paper products, screened overs, textile fiber/rope.

In preferred embodiments where the biomass particles of reduced size are hurds, the hurds are preferably processed into biodiesel or biochar using suitable equipment, such as, a pyrolysis machine. In some embodiments, the biochar is further pelletized into biochar pellets. In other preferred embodiments where the biomass particles of reduced size are bast fiber, the bast fiber is preferably processed into textile fiber, yarn, or wool using suitable equipment, such as, a textile spinning machine. In other preferred embodiments where the biomass particles of reduced size are fines, the fines are preferably processed into crude seed oil, e.g., hemp seed oil, using suitable equipment, such as, an oil extractor machine.

Additional advantages of the various embodiments of the disclosure will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present disclosure encompasses a variety of combinations and/or integrations of the specific embodiments described herein. As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the disclosure. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLE 1

### Liberation of Hemp Biomass

A cannabis (hemp) plant grown for its fiber qualities was processed through the mill. Without being pre-chopped or cut, a retted whole stalk round bale weighing ˜1,200 lbs and having a moisture content of ˜40% was manually unrolled and fed onto an incline, cleated rubber belt conveyor (˜4′ wide and ˜30′ long) comprising sidewalls extending vertically along each outside edge of the conveyor, to feed the unrolled (and not preprocessed) material into the liberating mill equipment inlet. The run time was ˜45 minutes, and during this time, the average amp pull was ˜154 amps. The processed material exited the outlet of the liberating mill at ˜7,000 feet per minute along with ˜12,000 cfm of air and moisture content of ˜<10%. The shelf gap clearance was set to ˜1/4′ and the speed was 60 hz.

### EXAMPLE 2

### Liberation of Hemp Biomass

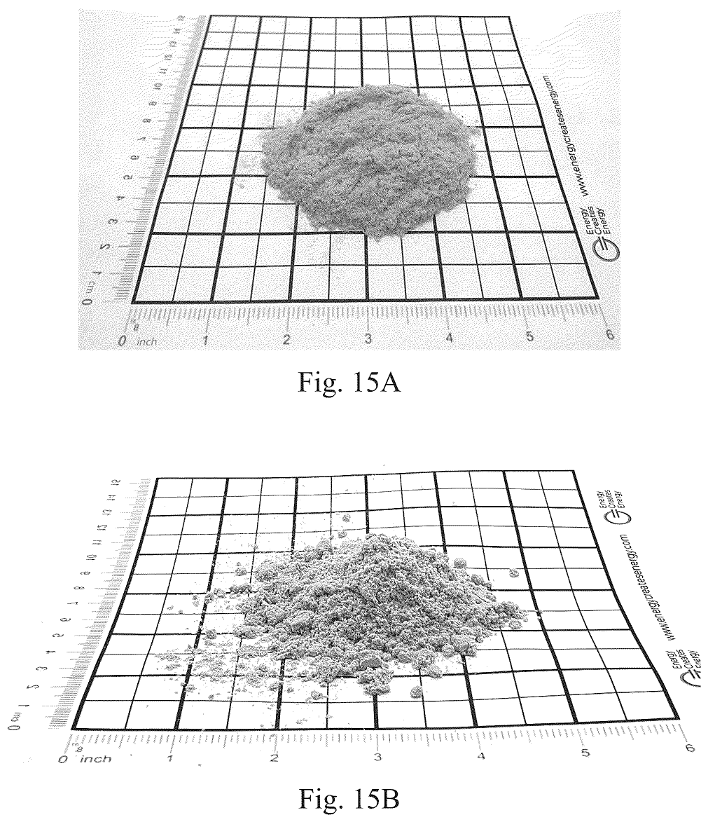

As shown in FIG. 7, whole hemp stalk was fed onto a conveyor belt without being pre-chopped, cut, or pre-treated. Photographs of the hemp processed by the liberating equipment are shown in FIGS. 8-10, 12-13, and 15A-B. FIG. 8 shows a photograph of the hemp particulates immediately as they exit the equipment after a single pass through the vertical impactor, consisting of hurd, fiber, and fines. The resulting hemp particulates can be further screened, sized, and separated as desired, but does not need to be further chopped, shredded, dried, or grinded, with resulting products from the various segregation processes shown in FIGS. 9-10, 12-13 and 15A-15B.

### EXAMPLE 3

### Particle Size Analysis

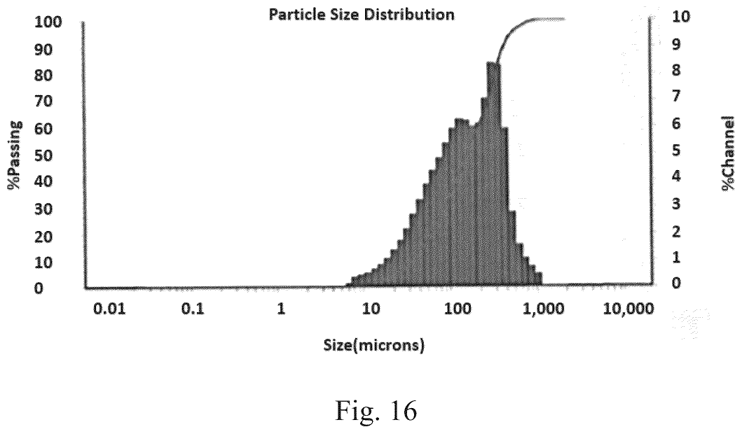

The resulting processed hemp from Example 1 was pulled from the mill and further processed through a micronizer as shown in FIGS. 3-4. The hemp was micronized and then analyzed using screening. The resulting products were a range of materials from fines to ultra-fines. The results are shown in Tables 1 and 2 above and FIGS. 11 and 14. Particularly, the analysis was run three times (30 second duration per run), generating the data shown in Table 3 (see also FIG. 16).

TABLE 3A
Hemp Stalk Particle Size Analysis Data

| Size (μm) | % Chan | % Pass |
|---|---|---|
| 2000 | 0.00 | 100.00 |
| 1674 | 0.00 | 100.00 |
| 1408 | 0.00 | 100.00 |
| 1184 | 0.00 | 100.00 |
| 995.6 | 0.45 | 100.00 |
| 837.2 | 0.73 | 99.55 |
| 704.0 | 1.05 | 98.82 |
| 592.0 | 1.55 | 97.77 |
| 497.8 | 2.76 | 96.22 |
| 418.6 | 5.91 | 93.46 |
| 352.0 | 8.29 | 87.55 |
| 296.0 | 8.37 | 79.26 |
| 248.9 | 7.03 | 70.89 |
| 209.3 | 6.11 | 63.86 |
| 176.0 | 5.96 | 57.75 |
| 148.0 | 6.20 | 51.79 |
| 124.5 | 6.26 | 45.59 |
| 104.7 | 5.91 | 39.33 |
| 88.00 | 5.35 | 33.42 |
| 74.00 | 4.81 | 28.07 |
| 62.23 | 4.33 | 23.26 |
| 52.33 | 3.82 | 18.93 |
| 44.00 | 3.25 | 15.11 |
| 37.00 | 2.68 | 11.86 |
| 31.11 | 2.16 | 9.18 |
| 26.16 | 1.72 | 7.02 |
| 22.00 | 1.36 | 5.30 |
| 18.50 | 1.06 | 3.94 |
| 15.56 | 0.82 | 2.88 |
| 13.08 | 0.65 | 2.06 |
| 11.00 | 0.52 | 1.41 |
| 9.25 | 0.43 | 0.89 |
| 7.78 | 0.36 | 0.46 |
| 6.54 | 0.10 | 0.10 |
| 5.50 | 0.00 | 0.00 |
| 4.63 | 0.00 | 0.00 |
| 3.89 | 0.00 | 0.00 |
| 3.27 | 0.00 | 0.00 |
| 2.750 | 0.00 | 0.00 |
| 2.313 | 0.00 | 0.00 |
| 1.945 | 0.00 | 0.00 |
| 1.635 | 0.00 | 0.00 |
| 1.375 | 0.00 | 0.00 |
| 1.156 | 0.00 | 0.00 |
| 0.972 | 0.00 | 0.00 |
| 0.818 | 0.00 | 0.00 |
| 0.688 | 0.00 | 0.00 |
| 0.578 | 0.00 | 0.00 |
| 0.486 | 0.00 | 0.00 |
| 0.409 | 0.00 | 0.00 |
| 0.344 | 0.00 | 0.00 |
| 0.2890 | 0.00 | 0.00 |
| 0.2430 | 0.00 | 0.00 |
| 0.2040 | 0.00 | 0.00 |
| 0.1720 | 0.00 | 0.00 |
| 0.1450 | 0.00 | 0.00 |
| 0.1220 | 0.00 | 0.00 |
| 0.1020 | 0.00 | 0.00 |
| 0.0860 | 0.00 | 0.00 |
| 0.0720 | 0.00 | 0.00 |
| 0.0610 | 0.00 | 0.00 |
| 0.0510 | 0.00 | 0.00 |
| 0.0430 | 0.00 | 0.00 |
| 0.0360 | 0.00 | 0.00 |
| 0.0300 | 0.00 | 0.00 |
| 0.02550 | 0.00 | 0.00 |

TABLE 3B
Percentiles of the Hemp Stalk
Particle Size Analysis Data
Percentiles

| % Tile | Size (μm) |
|---|---|
| 10.00 | 32.93 |
| 20.00 | 54.72 |
| 30.00 | 78.95 |
| 40.00 | 106.7 |
| 50.00 | 140.7 |
| 60.00 | 187.9 |
| 70.00 | 243.9 |
| 80.00 | 300.5 |
| 90.00 | 374.7 |
| 95.00 | 453.5 |

1. A process for one-pass size reduction of fibrous biomass comprising hemp, comprising:
introducing a fibrous biomass feedstock comprising hemp into an inlet of a vertical impact liberator comprising:
a housing having a plurality of sidewalls, a rotatable shaft, a plurality of cutter discs arranged in a spaced-apart stack along said rotatable shaft, and a fan assembly mounted inside the housing below the stack of cutter discs, said fan assembly comprising a fan disc having a direction of rotation and one or more fan blades connected to the fan disc for pulling air through said housing;
each cutter disc having an outer edge and at least one hammer mounted on the cutter disc and extending radially outwardly past the outer edge of the cutter disc,
said housing having a plurality of shelves extending inwardly from respective sidewall sections and presenting an inner edge, the at least one hammer rotating in closely spaced relation to an upper surface of the respective shelf,
wherein a gap is defined between the inner edge of the shelves and the outer edge of a respective cutter disc and hammer, wherein a chamber is formed between each opposing pair of cutter discs in the spaced-apart stack, said fibrous biomass feedstock comprising hemp being reduced in size as it passes through said gap and into each respective chamber; and
collecting one or more biomass particles of reduced size at an outlet of the vertical impact liberator.

2. The process of claim 1, wherein said one or more biomass particles of reduced size comprises particles selected from the group consisting of hurds, fibers, and fines of said hemp.

3. The process of claim 2, wherein said hurds have a particle size of about 0.075 mm to about 3 mm.

4. The process of claim 2, wherein said fibers have a length of about 0.5 mm to about 700 mm.

5. The process of claim 2, wherein said fibers are separated fibers.

6. The process of claim 2, wherein said fines have a particle size of about 0.075 mm to about 1 mm.

7. The process of claim 1, wherein said one or more biomass particles of reduced size has a reduced moisture content as compared to the fibrous biomass feedstock.

8. The process of claim 1, wherein said fibrous biomass feedstock comprises whole hemp stalks and straw.

9. The process of claim 1, wherein said fibrous biomass feedstock is only passed through said vertical impact liberator one time to yield said one or more biomass particles of reduced size.

10. The process of claim 1, wherein said fibrous biomass feedstock is not pre-dried before passing through said vertical impact liberator.

11. The process of claim 1, wherein said passing further comprises pulling the fibrous biomass feedstock through a first gap and into a first chamber, said pulling causes a successive decrease and increase of pressure within the fibrous biomass feedstock so as to yield said one or more biomass particles of reduced size.

12. The process of claim 1, wherein said rotatable shaft comprises a plurality of anti-wrap blocks.

13. The process of claim 1, wherein said housing further comprises at least one anti-wrap shield.

14. A vertical impact liberator for processing fibrous biomass feedstock comprising hemp into reduced particle size in a single pass, comprising:
an inlet configured to receive a fibrous biomass feedstock comprising hemp;
a housing connected to said inlet, said housing having a plurality of sidewalls, a rotatable shaft comprising a plurality of anti-wrap blocks, at least one anti-wrap shield, a plurality of cutter discs arranged in a spaced-apart stack along said rotatable shaft, and a fan assembly mounted inside the housing below the spaced-apart stack of cutter discs, said fan assembly comprising a fan disc having a direction of rotation and one or more fan blades connected to the fan disc for pulling air through said housing;
each cutter disc having an outer edge and at least one hammer mounted on the cutter disc and extending radially outwardly past the outer edge of the cutter disc,
said housing having a plurality of shelves extending inwardly from respective sidewall sections and presenting an inner edge, the at least one hammer rotating in closely spaced relation to an upper surface of the respective shelf, wherein a gap is defined between the inner edge of the shelves and the outer edge of a respective cutter disc and hammer,
wherein a chamber is formed between each opposing pair of cutter discs in the spaced-apart stack; and
an outlet configured to discharge biomass of reduced particle size.

15. The vertical impact liberator of claim 14, wherein said plurality of anti-wrap blocks are attached to a top surface of said rotatable shaft.

16. The vertical impact liberator of claim 14, wherein said at least one anti-wrap shield is arranged between said inlet and said rotatable shaft so as to prevent the fibrous biomass feedstock from accessing said rotatable shaft upon entering the housing.

17. The vertical impact liberator of claim 14, wherein said gap is adjustable.

18. A biodiesel or biochar prepared by processing said hurds produced according to claim 2 in a pyrolysis machine.

19. A textile fiber, yarn, or wool prepared by processing said bast fibers produced according to claim 2 in a textile spinning machine.

20. A crude seed oil prepared by processing said fines produced according to claim 2 in an oil extractor machine.
